(19) United States
(12) Patent Application Publication
(10) Pub. No.: US 2022/0272208 A1
(43) Pub. Date: Aug. 25, 2022

(54) TRANSMITTER, RECEIVER, AND COMMUNICATION SYSTEM

(71) Applicant: SONY SEMICONDUCTOR SOLUTIONS CORPORATION, KANAGAWA (JP)

(72) Inventor: NAOKI YOSHIMOCHI, KANAGAWA (JP)

(21) Appl. No.: 17/627,758

(22) PCT Filed: Jul. 21, 2020
(86) PCT No.: PCT/JP2020/028206

§ 371 Date: Jan. 17, 2022

(30) Foreign Application Priority Data
Jul. 30, 2019 (JP) 2019-139884

(51) Int. Cl. H04N 1/00; H04N 1/32

(52) U.S. Cl. CPC H04N 1/00095; H04N 1/32144; H04N 2201/0084

(57) ABSTRACT

A transmitter according to an embodiment of the present disclosure includes a cut-out section, a deriving section, a first processing unit, and a second processing unit. The cut-out section cuts out, from image data obtained by imaging, one or a plurality of pieces of ROI image data included in the image data. The deriving section derives ROI positional information in the image data. The first processing unit generates first transmission data corresponding to a first transmission method based on the one or the plurality of pieces of ROI image data and one or a plurality of pieces of the ROI positional information in the image data. The second processing unit generates second transmission data corresponding to a second transmission method based on the one or the plurality of pieces of ROI image data and the one or the plurality of pieces of the ROI positional information in the image data.

### TECHNICAL FIELD

The present disclosure relates to a transmitter, a receiver, and a communication system.

### BACKGROUND ART

In recent years, applications for transmitting large amounts of data having a large data volume have been increasing. Transmission systems are likely to be heavily loaded, and in the worst case, there is a possibility that the transmission systems may go down and data transmission may not be performed.

In order to prevent the transmission systems from going down, for example, instead of transmitting the entirety of a photographed image, only a partial image obtained by specifying an object to be photographed and cutting out the specified object has been transmitted. It is to be noted that, for example, the following patent literatures describe the cutting out of a partial image from a photographed image.

### CITATION LIST

### Patent Literature

PTL 1: Japanese Unexamined Patent Application Publication No. 2016-201756
PTL 2: Japanese Unexamined Patent Application Publication No. 2014-39219
PTL 3: Japanese Unexamined Patent Application Publication No. 2013-164834
PTL 4: Japanese Unexamined Patent Application Publication No. 2012-209831

### SUMMARY OF THE INVENTION

Incidentally, as a method used for transmission from an image sensor to an application processor, MIPI (Mobile Industry Processor Interface) CSI (Camera Serial Interface)-2, MIPI CSI-3, or the like may be used in some cases. In addition, as a method used for transmission from an application processor to a display, SLVS-EC (Scalable Low Voltage Signaling Embedded Clock) or the like may be used in some cases. It is desirable to provide a transmitter, a receiver, and a communication system that are adaptable to a plurality of transmission methods.

A transmitter according to an embodiment of the present disclosure includes a cut-out section, a deriving section, a first processing unit, and a second processing unit. The cut-out section cuts out, from image data obtained by imaging, one or a plurality of pieces of ROI image data included in the image data. The deriving section derives ROI positional information in the image data. The first processing unit generates first transmission data corresponding to a first transmission method on a basis of the one or the plurality of pieces of ROI image data and one or a plurality of pieces of the ROI positional information in the image data. The second processing unit generates second transmission data corresponding to a second transmission method on a basis of the one or the plurality of pieces of ROI image data and the one or the plurality of pieces of the ROI positional information in the image data.

In the transmitter according to an embodiment of the present disclosure, a processing block that cuts out, from image data obtained by imaging, the one or the plurality of pieces of ROI image data included in the image data and derives the ROI positional information in the image data is shared by the first transmission method and the second transmission method.

A receiver according to an embodiment of the present disclosure includes a first processing unit, a second processing unit, and a generation section. The first processing unit extracts one or a plurality of pieces of image data and one or a plurality of pieces of positional information from first transmission data corresponding to a first transmission method. The second processing unit extracts one or a plurality of pieces of image data and one or a plurality of pieces of positional information from second transmission data corresponding to a second transmission method. The generation section generates one or a plurality of pieces of ROI image data included in captured image data obtained by imaging on a basis of the one or the plurality of pieces of image data and the one or the plurality of pieces of positional information extracted by the first processing unit or the second processing unit.

In the receiver according to an embodiment of the present disclosure, a processing block that performs processing of generating the one or the plurality of pieces of ROI image data is shared by the first transmission method and the second transmission method.

A communication system according to an embodiment of the present disclosure includes a transmitter and a receiver. The transmitter has a configuration common to that of the transmitter described above. The receiver has a configuration common to that of the receiver described above.

In the communication system according to an embodiment of the present disclosure, a processing block that cuts out, from image data obtained by imaging, the one or the plurality of pieces of ROI image data included in the image data and derives the ROI positional information in the image data is shared by the first transmission method and the second transmission method. Further, a processing block that performs processing of generating the one or the plurality of pieces of ROI image data is shared by the first transmission method and the second transmission method.

### BRIEF DESCRIPTION OF THE DRAWINGS

FIG. 1 illustrates a schematic configuration example of a communication system.

FIG. 2 illustrates a schematic configuration example of an image sensor.

FIG. 3 illustrates a schematic configuration example of a processor.

FIG. 4 illustrates a configuration example of packets utilized in MIPI.

FIG. 5 illustrates a configuration example of transmission data utilized in MIPI.

FIG. 6 illustrates a configuration example of transmission data utilized in MIPI.

FIG. 7 illustrates a configuration example of a packet utilized in SLVS-EC.

FIG. 8 illustrates a configuration example of transmission data utilized in the SLVS-EC.

FIG. 9 illustrates a format example of the transmission data utilized in the SLVS-EC.

### MODES FOR CARRYING OUT THE INVENTION

Hereinafter, description is given in detail of embodiments of the present disclosure with reference to the drawings. The following description is given of specific examples of the present disclosure, and the present disclosure is not limited to the following aspects.

### 1. Embodiment

### [Configuration]

In recent years, in portable devices such as smartphones, camera devices, and the like, capacity of image data to be handled has been increased, and higher speed and lower power consumption have been demanded in data transmission in a device or between different devices. In order to meet such demands, standardization of high-speed interface specifications such as C-PHY specification and D-PHY specification defined by the MIPI alliance has been promoted as coupling interfaces for portable devices and camera devices. The C-PHY specification and the D-PHY specification are physical layer (physical layer: PHY) interface specifications for communication protocols. In addition, CSI for camera devices exists as an upper protocol layer of the C-PHY specification and the D-PHY specification. In addition, as the CSI for camera devices, SLVS-EC exists as a unique specification.

A communication system 1000 according to an embodiment of the present disclosure is a system that transmits and receives signals in accordance with one of MIPI CSI-2 specification or MIPI CSI-3 specification and SLVS-EC specification. The communication system 1000 is applicable, for example, to various electronic apparatuses such as a communication device such as a smart phone, a drone (an apparatus operable by remote control or operable autonomously), a mobile body such as an automobile, a computer such as PC (Personal Computer), a tablet-type device, and a gaming machine.

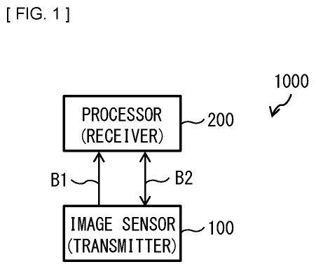

FIG. 1 illustrates a schematic configuration example of a communication system 1000 according to the present embodiment. The communication system 1000 is applied to transmission of data signals, clock signals and control signals, and includes an image sensor 100 (transmitter) and a processor 200 (receiver).

The image sensor 100 and the processor 200 are electrically coupled to each other by a data bus B1. The data bus B1 is a single signal transmission path that couples the image sensor 100 and the processor 200 to each other. Data representing an image (hereinafter, referred to as “image data”) to be transmitted from the image sensor 100 is transmitted from the image sensor 100 to the processor 200 via the data bus B1. The image sensor 100 and the processor 200 may be electrically coupled to each other by a bus (a control bus B2). The control bus B2 is another single signal transmission path that couples the image sensor 100 and the processor 200 to each other, and is a transmission path different from the data bus B1. Control data to be transmitted from the processor 200 is transmitted from the processor 200 to the image sensor 100 via the control bus B2.

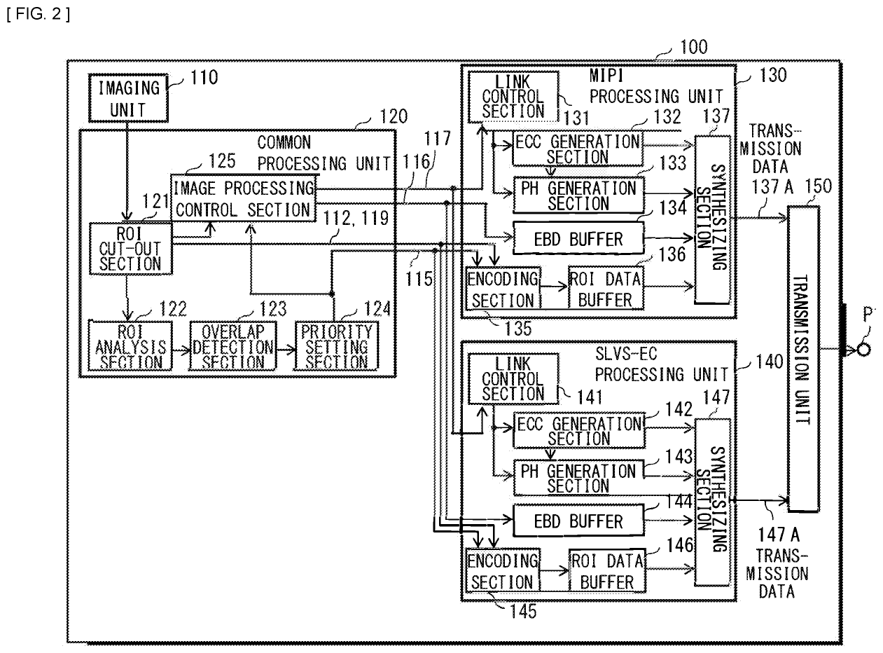

The image sensor 100 has an imaging function and a transmission function, and transmits image data generated by imaging. The image sensor 100 serves as a transmitter in the communication system 1000. Examples of the image sensor 100 include any type of image sensor devices that are able to generate an image, such as “an imaging device, e.g., a digital still camera, a digital video camera, or a stereo camera”, “an infrared sensor”, or “a range image sensor”, and the image sensor 100 has a function of transmitting the generated image. The image generated in the image sensor 100 corresponds to data indicative of a sensing result in the image sensor 100. Description is given later of an example of a configuration of the image sensor 100 later in detail with reference to FIG. 2.

The image sensor 100 transmits data corresponding to a region set for the image data (hereinafter, also referred to as “region image data”) by a transmission method described later. Control of transmission of the region image data is performed by, for example, a component (described later) that functions as an image processing unit in the image sensor 100. A region set for an image is called an ROI (Region Of Interest). In the following, a region set for the image is referred to as an “ROI”. In addition, the region image data is referred to as “ROI image data”.

Examples of processing related to setting of a region for the image include any processing that makes it possible to specify a partial region in the image (or any processing that makes it possible to cut out a partial region from the image), such as “processing of detecting an object from the image and setting a region including the detected object” or “processing of setting a region designated by an operation or the like on any operational device”.

The image sensor 100 transmits the ROI image data, i.e., transmits a portion of the image data, to thereby allow an amount of data related to the transmission to be smaller than that in transmitting the entire image data. Therefore, the transmission of the ROI image data by the image sensor 100 achieves various effects brought about by reduction in the amount of data, such as, shortening of transmission time or reduction in the load associated with the transmission in the communication system 1000, for example. It is to be noted that the image sensor 100 is also able to transmit the entire image data.

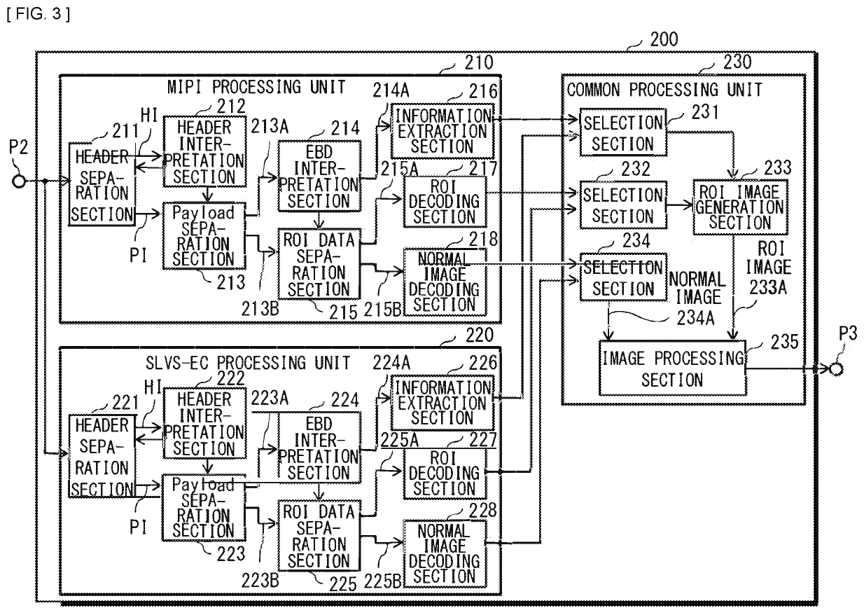

The processor 200 receives data transmitted from the image sensor 100, and processes the received data. The processor 200 serves as a receiver in the communication system 1000. An example of a configuration of processing of data transmitted from the image sensor 100 (configuration to serve as the receiver) is described later in detail with reference to FIG. 3.

The processor 200 includes, for example, one or two or more processors, which each include an arithmetic circuit such as MPU (Micro Processing Unit), or various processing circuits. The processor 200 performs various types of processing such as, processing related to control of recording of image data into a recording medium, processing related to control of image display on a display screen of a display device, and processing of executing arbitrary application software, for example. Examples of the processing related to the recording control include “processing of communicating, to the recording medium, control data including a recording command and data to be recorded into the recording medium”. In addition, examples of the processing related to the display control include “processing of communicating control data including a display command and data to be displayed on a display screen to a display device”. The processor 200 may transmit control information to the image sensor 100, for example, to thereby control functions in the image sensor 100. The processor 200 is also able to transmit region designation information to the image sensor 100, for example, to thereby control data transmitted from the image sensor 100.

### (Packet Structure)

Next, description is given of an example of a structure of a packet to be utilized for transmitting an image from the image sensor 100 to the processor 200 in the communication system 1000. In the communication system 1000, image data captured by the image sensor 100 is divided into partial image data in a row unit, and the partial image data for each row is transmitted by utilizing one or more packets. The same holds true also for the ROI image data.

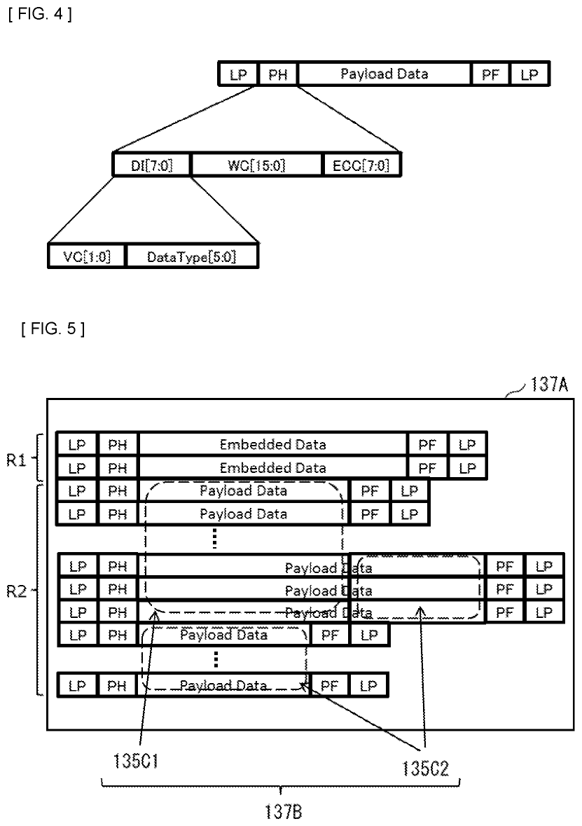

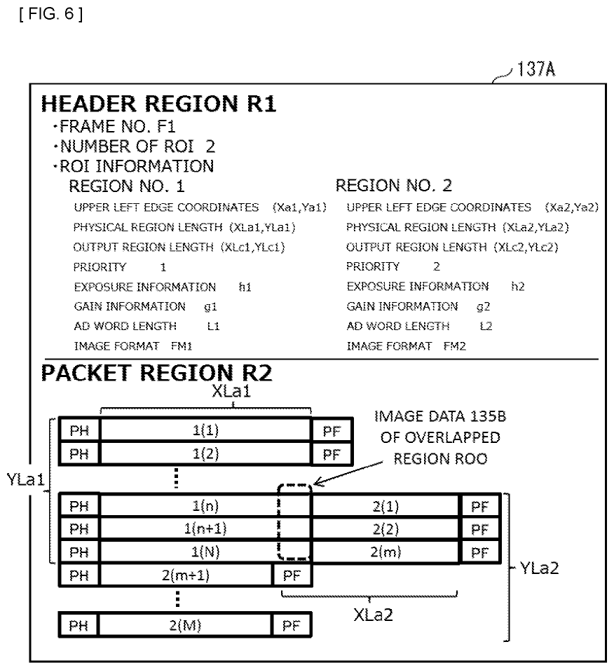

FIG. 4 illustrates an example of a structure of packets (Packet) to be utilized for transmitting image data in the communication system 1000. FIG. 4 illustrates an example of the structure of packets to be utilized in transmitting image data in accordance with MIPI CSI-2 specification or MIPI CSI-3 specification. FIGS. 5 and 6 each illustrate an example of transmission data 137A to be transmitted from the image sensor 100 to the processor 200 in the communication system 1000. FIGS. 5 and 6 each illustrate an example of the transmission data 137A utilized in transmitting image data in accordance with the MIPI CSI-2 specification or the MIPI CSI-3 specification.

As illustrated in FIG. 4, the packet to be utilized in transmitting the image data is started in a low power mode LP in a data stream, and is defined as a series of data ended in the low power mode LP. In addition, such packet includes a packet header PH, payload data (Payload Data), and a packet footer PF arranged in this order. The payload data (hereinafter, also referred to simply as “payload”) includes pixel data of a partial image in a row unit.

The packet header PH is, for example, a packet header of Payload Data of Long Packet. The Long Packet refers to a packet arranged between the packet head PH and the packet footer PF. The Payload Data of the Long Packet refers to primary data transmitted between devices. The packet header PH includes, for example, DI, WC, and ECC (Error-Correcting Code). The DI is a region that stores a data identifier. The DI includes VC (virtual channel) number and Data Type (data type of each ROI). The VC is a concept introduced for packet flow control, and is a mechanism to support a plurality of independent data streams sharing the same link. The WC is a region for indicating, to the processor 200, the end of the packet by the number of words. The WC includes, for example, a Payload length. The Payload length is, for example, the number of bytes included in the Payload of the Long Packet, and is, for example, the number of bytes for each ROI. The ECC is Payload Data ECC information including values to perform error detection or correction on the Payload Data. The ECC includes an error-correcting code.

The transmission data 137A includes, for example, image data frames as illustrated in FIGS. 5 and 6. The image data frame typically includes a header region, a packet region, and a footer region. In FIGS. 5 and 6, illustration of the footer region is omitted for the sake of convenience. In the image data frame, a header region R1 includes header information including Embedded Data and header ECC information to perform error detection or correction on the header information. The Embedded Data refers to additional information embeddable in the header or footer of the image data frame. At this time, the Embedded Data includes frame numbers, the number of the ROIs, and ROI information. The header ECC information includes values to perform error detection or correction on the header information. The header ECC information includes an error-correcting code.

The frame number is an identifier of the transmission data 137A. The number of the ROIs is the total number of ROIs included in the transmission data 137A. The ROI information is information about the ROI provided for each ROI included in the transmission data 137A.

The ROI information includes, for example, a region number (or priority) of one or a plurality of ROIs included in image data and positional information on one or a plurality of ROIs in the image data. The region number of the ROI is an identifier assigned to each ROI. The priority of the ROI is an identifier assigned to each ROI, and is determination information that makes it possible to determine which of the plurality of ROIs in the image data has been subjected to omission of an overlapped region.

The positional information on the ROI includes, for example, upper left edge coordinates (Xa, Ya) of the ROI, a length of the ROI in an X-axis direction length, and a length of the ROI in a Y-axis direction. The length of the ROI in the X-axis direction is, for example, a physical region length XLa of the ROI in the X-axis direction. The length of the ROI in the Y-axis direction is, for example, a physical region length YLa of the ROI in the Y-axis direction. The physical region length refers to a physical length (data length) of the ROI. The positional information on the ROI may include coordinates of a position different from the upper left edge of the ROI. The positional information on the ROI further includes, for example, an output region length XLc of the ROI in the X-axis direction and an output region length YLc of the ROI in the Y-axis direction. The output region length refers to, for example, a physical length (data length) of the ROI after a resolution thereof has been changed by performing thinning processing, pixel addition, or the like on the ROI.

The ROI information may further include, for each ROI, for example, sensing information, exposure information, gain information, AD (Analog-Digital) word length, image format, and the like, in addition to the positional information. The sensing information refers to contents of arithmetic operations on an object included in the ROI, supplementary information for subsequent-stage signal processing on the ROI image data, and the like. The exposure information refers to exposure time of the ROI. The gain information refers to gain information on the ROI. The AD word length refers to a word length of data per pixel having been AD-converted in the ROI. The image format refers to a format of the ROI image.

Further, as illustrated in FIGS. 5 and 6, in the data frame, a packet region R2 includes, for each line, the Payload Data of the Long Packet, and further includes the packet header PH and the packet footer PF at positions sandwiching the Payload Data of the Long Packet. Further, the low power modes LP are included at positions sandwiching the packet header PH and the packet footer PF.

In addition, the packet region R2 includes compressed image data 137B. The compressed image data 137B includes one piece of compressed image data or a plurality of pieces of compressed image data. Here, in FIG. 5, a packet group close to the packet header PH includes, for example, compressed image data 135C (135C1) of one ROI, and a packet group distant from the packet header PH includes, for example, compressed image data 135C (135C2) of another ROI. The two pieces of compressed image data 135C1 and 135C2 are included in the compressed image data 137B. The Payload Data of the Long Packet of each line includes pixel data for one line in the compressed image data 137B.

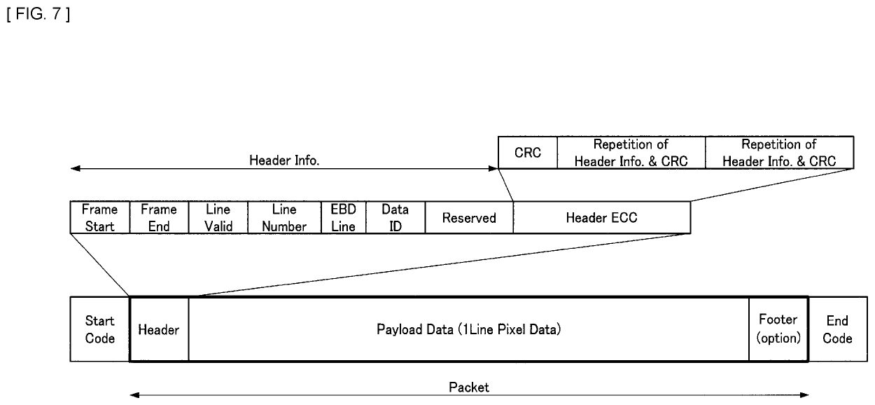

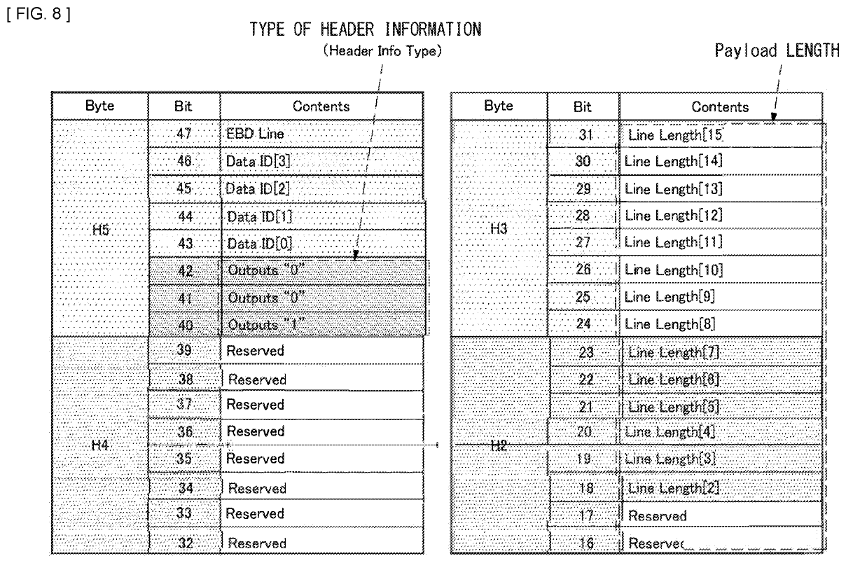

FIG. 7 illustrates an example of a structure of a packet (Packet) utilized for transmission of image data in the communication system 1000. FIG. 7 illustrates an example of the structure of the packet utilized in transmitting image data in the SLVS-EC specification. FIG. 8 illustrates an example of transmission data 147A to be transmitted from the image sensor 100 to the processor 200 in the communication system 1000.

As illustrated in FIG. 7, a packet utilized for the transmission of image data is defined as a series of data starting with a start code (Start Code) and ending with an end code (End Code) in a data stream. In addition, such packet includes the header (Header) and the payload data (Payload Data) arranged in this order. In addition, a footer (Footer) may be added at the back of the payload data. The payload data includes pixel data on a partial image in a row unit. The header includes various types of information concerning a row corresponding to the partial image included in the payload. The footer includes additional information (option).

The footer of the packet may include a CRC option or a payload data ECC option. The packet may include, for example, any of the following elements (1), (2), and (3):

(1) packet header+payload data;
(2) packet header+payload data+packet footer; and
(3) packet header+payload data with ECC.

The packet footer includes payload data ECC information to optionally perform error detection on the payload data. The packet is synthesized at TX LINK layer and decomposed at RX LINK layer in order to extract payload data or another auxiliary information. Description is given of an option (footer option) in the packet footer. In high-speed serial data transmission by a built-in clock, bit error characteristic of a PHY layer may cause a random data error in a portion of pixel data transferred as payload data. Therefore, it is necessary to consider that the pixel data is destroyed. The functions of detection and correction of payload data error allow for detection of such pixel data corruption and correction of the destroyed part to improve valid bit error performance of the entire interface.

The packet footer further includes the payload data ECC information to optionally perform error correction on the payload data. The performance and cost of the error correction circuit may be optimized by the functions in order to compensate a difference between a system level requirement of error tolerance and bit error characteristics in the PHY layer. The functions are also optional, and may be set by a configuration register (ECC option).

Here, description is given of information included in the header. As illustrated in FIG. 7, the header includes “Frame Start”, “Frame End”, “Line Valid”, “Line Number”, “EBD Line”, “Data ID”, “Reserved”, and “Header ECC”, in this order.

The Frame Start is one-bit information indicating a head of the frame. For example, a value of one is set for Frame Start of the header of a packet used for transmission of pixel data on the first line among data on an image to be transmitted, and a value of zero is set for Frame Start of the header of the packet used for transmission of pixel data on another line. It is to be noted that Frame Start corresponds to an example of “information indicating a start of the frame”.

Frame End is one-bit information indicating termination of the frame. For example, a value of one is set for Frame End of the header of a packet including, in the payload, pixel data on a terminal line of a valid pixel region among data on an image to be transmitted, and a value of zero is set for Frame End of the header of the packet used for transmission of pixel data on another line. It is to be noted that Frame End corresponds to an example of “information indicating an end of the frame”.

Frame Start and Frame End correspond to examples of frame information (Frame Information) which is information concerning a frame.

Line Valid is one-bit information indicating whether or not a line of pixel data stored in the payload is a line of valid pixels. A value of one is set for Line Valid of the header of a packet used for transmission of pixel data on a row in the valid pixel region, and a value of zero is set for Line Valid of the header of the packet used for transmission of the pixel data on the other line. It is to be noted that Line Valid corresponds to an example of “information indicating whether or not a corresponding row is valid”.

Line Number is 13-bit information indicating a row number of a row including pixel data stored in the payload.

EBD Line is one-bit information indicating whether or not to be a row having embedded data. That is, EBD Line corresponds to an example of “information indicating whether or not to be a row having embedded data”.

Data ID is four-bit information to identify each data (i.e., data included in the payload) in a case where data is transferred by being divided into a plurality of streams. It is to be noted that Data ID corresponds to an example of “identification information on data included in the payload.”

Line Valid, Line Number, EBD Line, and Data ID serve as row information (Line Information) which is information concerning the row.

Reserved is a 27-bit region for extension. It is to be noted that, in the following, such region indicated as Reserved is also referred to as an “extended region”. In addition, the total amount of data in the header information is six bytes.

As illustrated in FIG. 7, Header ECC arranged subsequent to the header information includes a CRC (Cyclic Redundancy Check) code, which is a two-byte error-detecting code calculated on the basis of six-byte header information. That is, Header ECC corresponds to an example of “information to perform error detection or correction on the header information”. In addition, Header ECC includes, subsequent to the CRC code, two pieces of the same information as eight-byte information which is a set of the header information and the CRC code.

The header is arranged at the head of the packet, and is used to store additional information other than the pixel data to be transferred before the payload data. The header includes header information and header ECC, and the additional information is stored in the header information. The header ECC stores CRC to detect errors in the header information and two repetitions of a combination of the header information and the CRC. In a case where an error occurs during transfer of the header information, the error is detected by the CRC, and another header information (in which no error is detected) repeatedly transferred is used to enable reproduction of correct header information on RX side.

The frame information is primarily transferred to establish frame synchronization within the system. Likewise, line information is used to establish line synchronization, and this information is assumed to be used to reproduce a synchronization relationship between image streams on the RX side when transmitting a plurality of image streams simultaneously using a plurality of SLVS-EC interfaces. As described above, the header ECC is used as a measure against a transfer error of the header information. In addition, the frame information and the line information are inputted from an application layer (CIS), and are transferred as they are to an application layer (DSP) on receiving side without being processed inside the interface. Similar transfer processing is performed also for reserved bits. Meanwhile, the header ECC is generated inside the interface, and is added to another information before being transferred; this information is assumed to be used by a link layer on the RX side.

That is, the header of one packet includes the same three sets of the header information and the CRC code. The data amount of the entire header totals to 24 bytes, including eight bytes of the first set of the header information and the CRC code, eight bytes of the second set of the header information and the CRC code, and eight bytes of the third set of the header information and the CRC code.

Here, description is given of an extended region (Reserved) provided in the header of the packet, with reference to FIG. 8. As illustrated in FIG. 8, in the extended region, information indicating types corresponding to information transmitted in a packet is set as header information type (Header Info Type) for three bits at the head. Depending on the header information type, a format of information (i.e., information type and a position at which such information is set) is determined, which is set in the remaining 24-bit region of the extended region excluding three bits in which such header information type is designated. This allows the receiving side to confirm the header information type to thereby be able to recognize what information is set at what position of another region of the extended region other than the region in which such header information type is designated, and thus to read such information.

For example, FIG. 8 illustrates an example of setting in a case where a payload length (in other words, a row length) of the packet is variable, as an example of methods of setting the header information type and using the extended region depending on such setting. Specifically, in the example illustrated in FIG. 8, a value is set, which corresponds to the type in a case where the payload length is variable, with respect to the header information type. More specifically, in the example illustrated in FIG. 8, “001” is set for the header information type. That is, in this case, the type corresponding to the “001” among the header information type means a type in a case where the payload length is variable. In addition, in the example illustrated in FIG. 8, 14 bits in the extended region are assigned to “Line Length”. The “Line Length” is information to notify the payload length. Such a configuration enables the receiving side to recognize that the payload length is variable on the basis of a value set as the header information type and to recognize the payload length by reading a value set as the “Line Length” in the extended region.

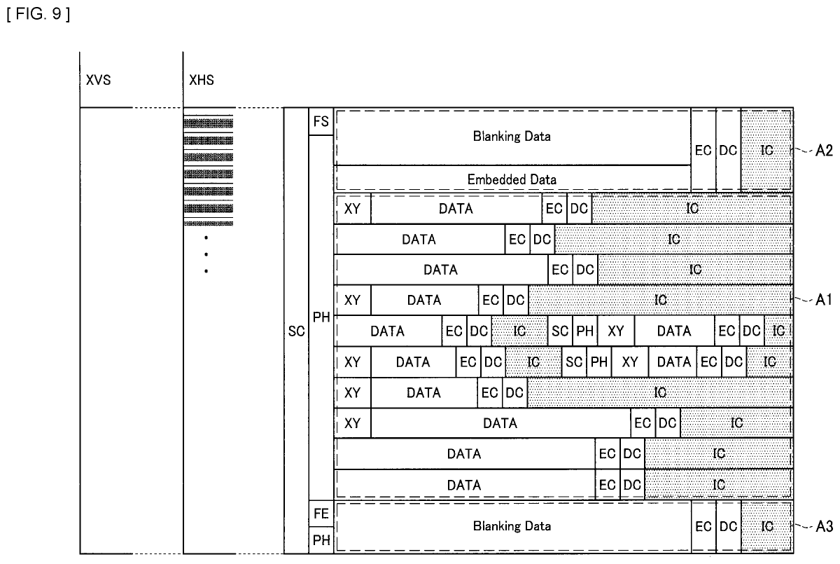

FIG. 9 illustrates an example of format of the transmission data 147A transmitted in SLVS-EC method specification. In FIG. 9, a series of packets indicated by a reference numeral A1 schematically illustrate packets by which image data on an ROI is transmitted. In addition, a series of packets indicated by reference numerals A2 and A3 correspond to packets different from the packets for transmitting the image data on the ROI. It is to be noted that, in the following description, in a case of distinguishing the packets indicated by the reference numerals A1, A2, and A3 from one another, they are also referred to as “packets A1”, “packets A2”, and “packets A3”, respectively, for the sake of convenience. That is, in a period in which one frame data is transmitted, a series of packets A2 are transmitted before a series of packets A1 are transmitted. In addition, a series of packets A3 may also be transmitted after the series of packets are transmitted.

In the example illustrated in FIG. 9, at least a portion of the series of packets A2 is utilized for transmission of the Embedded Data. For example, the Embedded Data may be stored in the payload of packetA2 before being transmitted. In addition, as another example, the Embedded Data may be stored in another region other than the payload of the packets A2 before being transmitted.

The Embedded Data corresponds to additional information to be additionally transmitted by the image sensor 100 (in other words, information embedded by the image sensor 100), and examples thereof include information concerning imaging conditions of images, information concerning an ROI, and the like. The Embedded Data includes, for example, information such as “ROI ID”, “upper left coordinates”, “height”, “width”, “AD word length (AD bit)”, “exposure”, “gain”, “sensing information”, and the like.

The information on the “ROI ID”, the “upper left coordinates”, the “height” and the “width” corresponds to information concerning the region (ROI) set in the image, and is utilized for restoring the image of such region on the receiving side, for example. Specifically, the “ROI ID” is identification information to identify each region. The “upper left coordinates” correspond to coordinates serving as an index of a position in an image of a region set for such image, and indicate the upper left vertex coordinates of a rectangular range in which such region is set. In addition, the “height” and the “width” indicate a height (a width in a vertical direction) and a width (a width in a horizontal direction) of the range of such a rectangular shape in which the region is set. It is to be noted that, among the Embedded Data, in particular, the above-mentioned information concerning the region (ROI) such as the “ROI ID”, the “upper left coordinates”, the “height”, and the “width” corresponds to an example of “region information” included in a first packet (e.g., packets A2).

The “exposure” information denotes exposure time related to imaging of the region (ROI). The “gain” information denotes a gain related to the imaging of such region. The AD word length (AD bit) denotes the word length of data per pixel having been AD-converted in such region. Examples of the sensing information include contents of arithmetic operations on an object (subject) included in such region, supplementary information for subsequent-stage signal processing on the image of such region, and the like.

It is to be noted that, in the example illustrated in FIG. 9, at least a portion of the packets A2 is utilized for the transmission of the Embedded Data, but at least a portion of the packets A3, instead of such packets A2, may be utilized for the transmission of the Embedded Data. In addition, in the following description, the Embedded Data is also referred to as “EBD”.

In FIG. 9, “SC” denotes “Start Code”, and is a symbol group indicating a start of the packet. The Start Code is prepended to the packets. The Start Code is represented by, for example, four symbols of K28.5, K27.7, K28.2, and K27.7 which are a combination of three types of K Characters.

“EC” denotes “End Code, and is a symbol group indicating the end of a packet. The End Code is appended to the end of the packet. The End Code is represented by, for example, four symbols of K28.5, K27.7, K30.7, and K27.7 which are a combination of three types of K Characters.

“PH” denotes “packet header (Packet Header)”, and corresponds to, for example, the header described with reference to FIG. 7. “FS” refers to an FS (Frame Start) packet. “FE” denotes an FE (Frame End) packet.

“DC” denotes “Deskew Code”, and is a symbol group utilized for correction of Data Skew between lanes, i.e., deviation in reception timings of pieces of data received in the respective lanes on the receiving side. The Deskew Code is represented by, for example, four symbols of K28.5 and Any**.

“IC” denotes “Idle Code”, and is a symbol group that is repeatedly transmitted during a period other than the time of transmission of packet data. The Idle Code is represented by, for example, D00.0 (00000000) of D Character which is 8B10B Code.

“DATA” denotes region data (i.e., pixel data on a portion corresponding to a region set in the image) stored in the payload.

“XY” corresponds to information indicating, as an X coordinate and a Y coordinate, a left edge position (position in an image) of a partial region corresponding to region data stored in the payload. It is to be noted that, in the following, the X coordinate and the Y coordinate indicating the position at the left edge of the partial region, which are denoted by “XY”, are also simply referred to as “X-Y coordinates of the partial region”.

The X-Y coordinates of the partial region are stored at the head of the payload of the packets A1. In addition, the X-Y coordinates of the partial region may be omitted in the packets A1 transmitted later, in a case where there is no change in the X coordinate of corresponding partial regions between continuously transmitted packets A1 and only +1 is added to the Y coordinate. It is to be noted that the present control is described later separately with reference to a specific example.

In addition, in the SLVS-EC, in a case of transmitting region data on a partial region corresponding to each of a plurality of regions spaced apart from each other in the horizontal direction, for each row in which such a plurality of regions are set, the packets A1 for each of such a plurality of regions are individually generated and transmitted. That is, for rows in which two regions spaced apart from each other in the horizontal direction are set, two packets A1 are generated and transmitted.

### (Image Sensor 100)

FIG. 2 illustrates an example of a configuration of the image sensor 100. The configuration illustrated in FIG. 2 corresponds to a specific example of a CSI transmitter. The image sensor 100 includes, for example, an imaging unit 110, a common processing unit 120, an MIPI processing unit 130, an SLVS-EC processing unit 140, and a transmission unit 150. The image sensor 100 transmits one of the transmission data 137A and the transmission data 147A generated by performing predetermined processing on image data 111 obtained by the imaging unit 110 to the processor 200 via the data bus B1.

The imaging unit 110 converts an optical image signal obtained through an optical lens or the like, for example, into image data. The imaging unit 110 includes, for example, a CCD (Charge Coupled Device) image sensor or a CMOS (Complementary Metal Oxide Semiconductor) image sensor, for example. The imaging unit 110 includes an analog-to-digital conversion circuit, and converts analog image data into digital image data. Data form after the conversion may be a YCbCr form in which a color of each pixel is represented by a luminance component Y and color-difference components Cb and Cr, or may be an RGB form. The imaging unit 110 outputs the image data 111 (digital image data) obtained by imaging to the common processing unit 120.

The common processing unit 120 is a circuit that performs predetermined processing on the image data 111 inputted from the imaging unit 110. In a case where a control signal instructing cutout of the ROI is inputted from the processor 200 via the control bus B2, the common processing unit 120 performs predetermined processing on the image data 111 inputted from the imaging unit 110. Consequently, the common processing unit 120 generates various types of data (one or a plurality of pieces of ROI image data 112, one or a plurality of pieces of ROI information 116, and frame information 117), and outputs the generated various types of data to the MIPI processing unit 130 and the SLVS-EC processing unit 140. In a case where a control signal instructing output of a normal image is inputted from the processor 200 via the control bus B2, the common processing unit 120 performs predetermined processing on the image data 111 inputted from the imaging unit 110. Consequently, the common processing unit 120 generates image data 119, and outputs the generated image data 119 to the MIPI processing unit 130 and the SLVS-EC processing unit 140.

The MIPI processing unit 130 is a circuit that generates the transmission data 137A corresponding to a transmission method of the MIPI CSI-2 specification or the MIPI CSI-3 specification on the basis of the various types of data (the one or the plurality of pieces of ROI image data 112, the one or the plurality of pieces of ROI information 116, and the frame information 117) inputted from the common processing unit 120. The SLVS-EC processing unit 140 is a circuit that generates the transmission data 147A corresponding to a transmission method of the SLVS-EC specification on the basis of the various types of data (the one or the plurality of pieces of ROI image data 112, the one or the plurality of pieces of ROI information 116, and the frame information 117) inputted from the common processing unit 120. The transmission unit 150 transmits a packet (one of the transmission data 137A and the transmission data 147A) transmitted from one of the MIPI processing unit 130 and the SLVS-EC processing unit 140 to the processor 200 via the data bus B1 for each row.

The common processing unit 120 includes, for example, an ROI cut-out section 121, an ROI analysis section 122, an overlap detection section 123, a priority setting section 124, and an image processing control section 125.

In a case where a control signal instructing cutout of the ROI is inputted from the processor 200 via the control bus B2, the ROI cut-out section 121 specifies one or a plurality of objects to be photographed included in the image data 111 inputted from the imaging unit 110, and sets the ROI for each of the specified objects. The ROI is, for example, a rectangular region including the specified object. The ROI cut-out section 121 cuts out image data on the one or the plurality of ROIs (the one or the plurality of pieces of ROI image data 112) from the image data 111. The ROI cut-out section 121 cuts out, from the image data 111, the one or the plurality of pieces of ROI image data 112 included in the image data 111. The ROI cut-out section 121 further assigns a region number as an identifier to each of the set ROIs. For example, in a case where two ROIs are set in the image data 111, the ROI cut-out section 121 assigns region number one to one ROI (ROI1) and assigns region number two to the other ROI (ROI2). The ROI cut-out section 121 stores, for example, the assigned identifier (region number) in a storage section. The ROI cut-out section 121 stores, for example, each ROI image data 112 cut out from the image data 111 in the storage section. The ROI cut-out section 121 further stores, for example, an identifier (region number) assigned to each ROI in the storage section in association with the ROI image data 112. It is to be noted that, in a case where a control signal instructing output of a normal image is inputted from the processor 200 via the control bus B2, the ROI cut-out section 121 performs predetermined processing on the image data 111 inputted from the imaging unit 110 to thereby generate the image data 119.

The ROI analysis section 122 derives positional information 113 of the ROI in the image data 111 for each ROI. For example, the ROI analysis section 122 stores the derived positional information 113 in the storage section. For example, the ROI analysis section 122 stores it in the storage section in association with the identifier (region number) assigned to the ROI.

When a plurality of objects to be photographed are specified in the image data 111, the overlap detection section 123 detects an overlapped region (ROO (Region Of Overlap)) where two or more ROIs overlap each other, on the basis of the positional information 113 on the plurality of ROIs in the image data 111. That is, the overlap detection section 123 derives positional information 114 on the overlapped region ROO in the image data 111 for each overlapped region ROO. The overlap detection section 123 stores, for example, the derived positional information 114 in the storage section. For example, the overlap detection section 123 stores the derived positional information 114 in the storage section in association with the overlapped region ROO. The overlapped region ROO is, for example, a square region having the same size as or smaller than the smallest ROI of two or more ROIs overlapping each other.

The priority setting section 124 assigns priority 115 to each ROI in the image data 111. For example, the priority setting section 124 stores the assigned priority 115 in the storage section. For example, the priority setting section 124 stores the assigned priority 115 in the storage section in association with the ROI. In addition to the region number assigned to each ROI, the priority setting section 124 may assign the priority 115 to each ROI or may replace the priority 115 with the region number assigned to each ROI. For example, the priority setting section 124 may store the priority 115 in the storage section in association with the ROI, or may store the region number assigned to each ROI in the storage section in association with the ROI.

The priority 115 is an identifier of each ROI, and is determination information that is able to determine which of the plurality of ROIs in the image data 111 has been subjected to omission of the overlapped region ROO. For example, the priority setting section 124 assigns one as the priority 115 to one ROI of two ROIs each including the overlapped region ROO, and assigns two as the priority 115 to the other ROI thereof. In this case, upon creation of transmission image data 135A described later, the ROI having a larger numerical value of the priority 115 is subjected to omission of the overlapped region ROO. It is to be noted that the priority setting section 124 may assign, as the priority 115, the same number as the region number assigned to each ROI to the ROI. For example, the priority setting section 124 stores the priority 115 assigned to each ROI in the storage section in association with the ROI image data 112. The priority setting section 124 outputs the region number or the priority 115 assigned to each ROI to the MIPI processing unit 130 and the SLVS-EC processing unit 140.

The image processing control section 125 generates the ROI information 116 and the frame information 117, and outputs them to the MIPI processing unit 130 and the SLVS-EC processing unit 140. The ROI information 116 includes, for example, each positional information 113. The ROI information 116 further includes, for example, at least one of the data type of each ROI, the number of ROIs included in the image data 111, the positional information 114 on the overlapped region, the region number (or the priority 115) of each ROI, the data length of each ROI, or the image format of each ROI. The frame information 117 includes, for example, the number of a virtual channel assigned to each frame, the data type of each ROI, Payload length of each line, and the like. The data type includes, for example, YUV data, RGB data, RAW data, or the like. The data type further includes, for example, data in an ROI form or data in a normal form.

The MIPI processing unit 130 is a circuit that generates and sends the transmission data 137A corresponding to a transmission method of the MIPI CSI-2 specification or the MIPI CSI-3 specification, on the basis of the various types of data (the one or the plurality of pieces of ROI image data 112, the one or the plurality of pieces of ROI information 116, and the frame information 117) inputted from the common processing unit 120. The MIPI processing unit 130 sends, in the Embedded Data, the ROI information 116 on each ROI in the image data 111. In a case where a control signal instructing cutout of the ROI is inputted from the processor 200 via the control bus B2, the MIPI processing unit 130 further sends, in the Payload Data of the Long Packet, the image data (the compressed image data 135C) of each ROI. At this time, the MIPI processing unit 130 sends the image data (the compressed image data 135C) of each ROI via a common virtual channel. In addition, the MIPI processing unit 130 sends, in an image data frame, the image data (the compressed image data 135C) of each ROI, and sends, in a header of the image data frame, the ROI information 116 on each ROI. In addition, in a case where a control signal instructing output of a normal image is inputted from the processor 200 via the control bus B2, the MIPI processing unit 130 also sends, in the Payload Data of the Long Packet, normal image data (compressed image data 135D).

The MIPI processing unit 130 includes, for example, a LINK control section 131, an ECC generation section 132, a PH generation section 133, an EBD buffer 134, an encoding section 135, an ROI data buffer 136, and a synthesizing section 137.

For example, the LINK control section 131 outputs the frame information 117 for each row to the ECC generation section 132 and the PH generation section 133. On the basis of, for example, data of one line (e.g., the number of virtual channels, the data type of each ROI, Payload length of each line, etc.) in the frame information 117, the ECC generation section 132 generates an error-correcting code for the line. For example, the ECC generation section 132 outputs the generated error-correcting code to the PH generation section 133. The PH generation section 133 generates the packet header PH for each line using, for example, the frame information 117 and the error-correcting code generated by the ECC generation section 132. The PH generation section 143 outputs the generated packet header PH to a synthesizing section 147.

The EBD buffer 134 temporarily stores the one or the plurality of pieces of ROI information 116, and outputs the one or the plurality of pieces of ROI information 116 as the Embedded Data to the synthesizing section 137 at a predetermined timing.

In a case where a control signal instructing cutout of the ROI is inputted from the processor 200 via the control bus B2, the encoding section 135 generates one or a plurality of pieces of transmission image data 135A on the basis of the one or the plurality of pieces of ROI image data 112 obtained from the image data 111 and the priority 115 corresponding to the one or the plurality of pieces of ROI image data 112. The encoding section 135 generates the plurality of pieces of transmission image data 135A having been subjected to omission of image data 135B from the plurality of pieces of ROI image data 112 obtained from the image data 111 not to allow the image data 135B of the overlapped region ROO to be included in an overlapped manner in the plurality of pieces of ROI image data 112 obtained from the image data 111.

In a case where a control signal instructing cutout of the ROI is inputted from the processor 200 via the control bus B2, the encoding section 135 further encodes the one or the plurality of pieces of transmission image data 135A to generate the compressed image data 135C. The encoding section 135 compresses the one or the plurality of pieces of transmission image data 135A by a compression form, or the like conforming to JPEG specification, for example, to thereby generate the compressed image data 135C. In a case where a control signal instructing output of a normal image is inputted from the processor 200 via the control bus B2, the encoding section 135 encodes the image data 119 to generate the compressed image data 135D. The encoding section 135 compresses the image data 119 by a compression form, or the like conforming to JPEG specification, for example, to thereby generate compressed image data 135E.

The ROI data buffer 136 temporarily stores the compressed image data 135C or the compressed image data 135D, and outputs the compressed image data 135C or the compressed image data 135D to the synthesizing section 137 as the Payload Data of the Long Packet at a predetermined timing.

The synthesizing section 137 generates the transmission data 137A on the basis of the inputted various types of data (the packet header PH, the ROI information 116, and the compressed image data 135C or the compressed image data 135D). The synthesizing section 137 outputs the generated transmission data 137A to the transmission unit 150. That is, the synthesizing section 137 sends Data Type (data type of each ROI) to be included in the packet header PH of the Payload Data of the Long Packet. In addition, the synthesizing section 137 sends the image data (the compressed image data 135C) of each ROI via a common virtual channel. The synthesizing section 137 synthesizes the ROI information 116 as the Embedded Data with the transmission data 137A. The synthesizing section 137 synthesizes, with the transmission data 137A, the header information including the Embedded Data and the header ECC information to perform error detection or correction on the header information. The synthesizing section 137 syntheses, with the transmission data 137A, the Payload Data ECC information to perform error detection or correction on the Payload Data. The synthesizing section 137 synthesizes the compressed image data 135C or the compressed image data 135D as the Payload Data with the transmission data 137A.

For example, the synthesizing section 137 arranges pieces of the compressed image data 135C separately for respective pixel rows of the compressed image data 135C, in the packet region R2 of the transmission data 137A. Accordingly, the packet region R2 of the transmission data 137A includes no overlapped compressed image data corresponding to the image data 135B of the overlapped region ROO. In addition, for example, the synthesizing section 137 omits a pixel row not corresponding to each transmission image data 135A of the image data 111, in the packet region R2 of the transmission data 137A. Accordingly, the packet region R2 of the transmission data 137A includes no pixel row not corresponding to each transmission image data 135A of the image data 111. It is to be noted that, in the packet region R2 of FIG. 6, a part surrounded by a broken line corresponds to the compressed image data of the image data 135B on the overlapped region ROO.

A boundary between a packet group close to the packet header PH (e.g., 1 (n) in FIG. 6) and a packet group distant from the packet header PH (e.g., 2 (1) in FIG. 6)) is specified by a physical region length XLa1 of the ROI image data 112 corresponding to the compressed image data of the packet group close to the packet header PH (e.g., 1 (n) in FIG. 6). In the compressed image data corresponding to the image data 135B of the overlapped region ROO included in the packet group close to the packet header PH (e.g., 1 (n) in FIG. 6), the start position of the packet is specified by a physical region length XLa2 of the ROI image data 112 corresponding to the packet group distant from the packet header PH (e.g., 2 (1) in FIG. 6).

The synthesizing section 137 may include, in the Payload Data of the Long Packet, for example, the ROI information 116, in addition to pixel data for one line in the compressed image data 135C, for example, upon generation of the Payload Data of the Long Packet for each row, in the packet region R2 of the transmission data 137A, for example. That is, the synthesizing section 137 may send the ROI information 116 to be included in the Payload Data of the Long Packet. At this time, the ROI information 116 includes, for example, at least one of the number of ROIs included in the image data 111 (the number of ROIs), the region number of each ROI (or the priority 115), the data length of each ROI, or the image format of each ROI. The ROI information 116 is preferably arranged at an edge part on side of the packet header PH in the Payload Data of the Long Packet (i.e., at the head of the Payload Data of the Long Packet).

The SLVS-EC processing unit 140 is a circuit that generates and sends the transmission data 147A corresponding to the transmission method of the SLVS-EC specification on the basis of the various types of data (the one or the plurality of pieces of ROI image data 112, the one or the plurality of pieces of ROI information 116, and the frame information 117) inputted from the common processing unit 120. In a case where a control signal instructing cutout of the ROI is inputted from the processor 200 via the control bus B2, the SLVS-EC processing unit 140 further sends, in the Payload Data, the image data (compressed image data 145C) of each ROI. In a case where a control signal instructing output of a normal image is inputted from the processor 200 via the control bus B2, the SLVS-EC processing unit 140 also sends normal image data (compressed image data 145D).

The SLVS-EC processing unit 140 includes, for example, a LINK control section 141, an ECC generation section 142, a PH generation section 143, an EBD buffer 144, an encoding section 145, an ROI data buffer 146, and the synthesizing section 147.

For example, the LINK control section 141 outputs the frame information 117 for each line to the ECC generation section 142 and the PH generation section 143. On the basis of, for example, data of one line (e.g., Frame Start, Frame End, etc.) in the frame information 117, the ECC generation section 142 generates an error-correcting code for the line. For example, the ECC generation section 142 outputs the generated error-correcting code to the PH generation section 143. The PH generation section 143 generates the packet header for each line using, for example, the frame information 117 and the error-correcting code generated by the ECC generation section 142. In a case of transmitting the region data, the PH generation section 143 sets information indicating that information on the region (e.g., region data) is transmitted as the header information type to an extended region of the packet header, as described above. Moreover, the PH generation section 143 sets information indicating that the region data is transmitted by utilizing the payload to at least a portion of the extended region. In addition, the PH generation section 143 sets, for a packet in which coordinates of a region are inserted into the payload, information indicating that the coordinates of the region are transmitted by utilizing the payload, to at least a portion of the extended region. The PH generation section 143 outputs the generated packet header to the synthesizing section 147. It is to be noted that the PH generation section 143 may place the region data in the Embedded Data instead of the payload.

The EBD buffer 144 temporarily stores additional information (the one or the plurality of pieces of ROI information 116) transmitted from the common processing unit 120, and outputs the one or the plurality of pieces of ROI information 116 as the Embedded Data to the synthesizing section 147 at a predetermined timing.

In a case where a control signal instructing cutout of the ROI is inputted from the processor 200 via the control bus B2, the encoding section 145 generates one or a plurality of pieces of transmission image data 145A on the basis of the one or the plurality of pieces of ROI image data 112 obtained from the image data 111 and the priority 115 corresponding to the one or the plurality of pieces of ROI image data 112. The encoding section 145 generates the plurality of pieces of transmission image data 145A having been subjected to omission of image data 145B from the one or the plurality of pieces of ROI image data 112 obtained from the image data 111 not to allow the image data 145B of the overlapped region ROO to be included in an overlapped manner in the plurality of pieces of ROI image data 112 obtained from the image data 111.

In a case where a control signal instructing cutout of the ROI is inputted from the processor 200 via the control bus B2, the encoding section 145 further encodes the one or the plurality of pieces of transmission image data 145A to generate the compressed image data 145C. The encoding section 145 compresses the one or the plurality of pieces of transmission image data 145A by a compression form, or the like conforming to JPEG specification, for example, to thereby generate the compressed image data 145C. In a case where a control signal instructing output of a normal image is inputted from the processor 200 via the control bus B2, the encoding section 145 encodes the image data 119 to generate the compressed image data 145D. The encoding section 145 compresses the image data 119 by a compression format, or the like conforming to JPEG specification, for example, to thereby generate the compressed image data 145D.

The ROI data buffer 146 temporarily stores the compressed image data 145C or the compressed image data 145D, and outputs the compressed image data 145C or the compressed image data 145D to the synthesizing section 147 at a predetermined timing.

The synthesizing section 147 generates the transmission data 147A on the basis of the inputted various types of data (the packet header, the additional information, and the compressed image data 145C or the compressed image data 145D). The synthesizing section 147 synthesizes the ROI information 116 as the Embedded Data with the transmission data 147A. The synthesizing section 147 synthesizes, with the transmission data 147A, the header information including the Embedded Data and the header ECC information to perform error detection or correction on the header information. The synthesizing section 147 outputs the generated transmission data 147A to the transmission unit 150. The synthesizing section 147 syntheses, with the transmission data 147A, the Payload Data ECC information to perform error detection or correction on the Payload Data. The synthesizing section 147 synthesizes the compressed image data 145C or the compressed image data 145D as the Payload Data with the transmission data 147A.

For example, in a case where three ROIs (ROI1, ROI2, and ROI3) are set, the synthesizing section 147 transmits, in the packets A2, the region information on each ROI as a portion of the additional information (the Embedded Data), and transmits, in the packets A1, the region data corresponding to each ROI for each row.

The transmission unit 150 transmits one of the transmission data 137A and the transmission data 147A to the processor 200 via the data bus B1. The transmission unit 150 transmits, to the processor 200, a packet transmitted from one of the synthesizing section 137 and the synthesizing section 147, for each row via the data bus B1. An output of the transmission unit 150 is coupled to an output pin P1 coupled to the data bus B1, for example.

### (Processor 200)

Next, description is given of the processor 200. FIG. 3 illustrates an example of a configuration of the processor 200. The configuration illustrated in FIG. 3 corresponds to a specific example of a CSI receiver. The processor 200 is, for example, an apparatus that receives signals in a common specification to that of the imaging sensor 100 (e.g., one of the MIPI CSI-2 specification or the MIPI CSI-3 specification, and the SLVS-EC specification).

The processor 200 includes, for example, an MIPI processing unit 210, an SLVS-EC processing unit 220, and a common processing unit 230. The MIPI processing unit 210 and the SLVS-EC processing unit 220 are circuits that receive one of the transmission data 137A and the transmission data 147A outputted from the image sensor 100 via the data bus B1, and perform predetermined processing on the received transmission data to thereby generate various types of data (112, 116, and 117) and output them to the common processing unit 230. An input of the MIPI processing unit 210 and an input of the SLVS-EC processing unit 220 are coupled to a common input pin P2 coupled to the data bus B1, for example. This makes it possible to reduce the number of input pins, as compared with a case of providing input pins separately. The various types of data (112, 116, and 117) which are outputs from the MIPI processing unit 210 and the various types of data (112, 116, and 117) which are outputs from the SLVS-EC processing unit 220 have data formats equal to each other.

The common processing unit 230 is a circuit that generates ROI image 233A on the basis of the various types of data (112, 116, and 117) received from one of the MIPI processing unit 210 and the SLVS-EC processing unit 220. The common processing unit 230 is a circuit that generates normal image 234A on the basis of the data (119) received from one of the MIPI processing unit 210 and the SLVS-EC processing unit 220. The output of the MIPI processing unit 210 and the output of the SLVS-EC processing unit 220 have the data format equal to each other, and thus the common processing unit 230 includes no dedicated processing circuit for the output of the MIPI processing unit 210 and no dedicated processing circuit for the output of the SLVS-EC processing unit 220. That is, it is possible for the common processing unit 230 to process the outputs of both the MIPI processing unit 210 and the SLVS-EC processing unit 220 using a common processing circuit.

The MIPI processing unit 210 extracts the one or the plurality of pieces of ROI image data 112 and the one or the plurality of pieces of ROI information 116 from the transmission data 137A corresponding to the MIPI CSI-2 specification or the MIPI CSI-3 specification. The MIPI processing unit 210 includes, for example, a header separation section 211, a header interpretation section 212, a Payload separation section 213, an EBD interpretation section 214, an ROI data separation section 215, an information extraction section 216, an ROI decoding section 217, and a normal image decoding section 218.

The header separation section 211 receives the transmission data 137A from the image sensor 100 via the data bus B1. That is, the header separation section 211 includes, in the Embedded Data, the ROI information 116 for each ROI in the image data 111, and receives the transmission data 137A including the image data (the compressed image data 135C) of each ROI in the Payload Data of the Long Packet. The header separation section 211 separates the received transmission data 137A in accordance with a rule defined by the MIPI CSI-2 specification or the MIPI CSI-3 specification. The header separation section 211 separates the received transmission data 137A for the header region R1 and the packet region R2.

The header interpretation section 212 specifies a position of the Payload Data of the Long Packet included in the packet region R2 on the basis of the data (specifically, the Embedded Data) included in the header region R1. The Payload separation section 213 separates the Payload Data of the Long Packet included in the packet region R2 from the packet region R2 on the basis of the position of the Payload Data of the Long Packet specified by the header interpretation section 212.

The EBD interpretation section 214 outputs the Embedded Data as EBD data 214A to the information extraction section 216. The EBD interpretation section 214 further determines, from data types included in the Embedded Data, whether the image data included in the Payload Data of the Long Packet is the compressed image data 135C of the image data of the ROI (the ROI image data 112) or the compressed image data 135D of the normal image data (the image data 119). The EBD interpretation section 214 outputs a determination result to the ROI data separation section 215.

In a case where the image data included in the Payload Data of the Long Packet is the compressed image data 135C of the image data of the ROI (the ROI image data 112), the ROI data separation section 215 outputs the Payload Data of the Long Packet as Payload Data 215A to the ROI decoding section 217. In a case where the image data included in the Payload Data is the compressed image data 135D of the normal image data (the image data 119), the ROI data separation section 215 outputs the Payload Data of the Long Packet as Payload Data 215B to the normal image decoding section 218. In a case where the Payload Data of the Long Packet includes the ROI information 116, the Payload Data 215A includes the ROI information 116 and pixel data for one line of the compressed image data 135C.

The information extraction section 216 extracts the one or the plurality of pieces of ROI information 116 from the Embedded Data included in the EBD data 214A. For example, the information extraction section 216 extracts, from the Embedded Data included in the EBD data 214A, for example, the number of ROIs included in the image data 111, the region number (or the priority 115) of each ROI, the data length of each ROI, and the image format of each ROI. That is, the transmission data 137A includes the region number (or the priority 115) of the ROI corresponding to each ROI image data 112, as determination information that is able to determine which of the plurality of pieces of ROI image data 112 obtained from such transmission data 137A has been subjected to omission of an image 118 of the overlapped region ROO.

The information extraction section 216 extracts, from the Embedded Data included in the EBD data 214A, for example, the coordinates (e.g., upper left edge coordinates (Xa1, Ya1)), the length (e.g., physical region length XLa1, YLa1), and region number one (or the priority 115 (=1)) of the ROI corresponding to one ROI image data 112. The information extraction section 216 further extracts, from the Embedded Data included in the EBD data 214A, for example, the coordinates (e.g., upper left edge coordinates (Xa2, Ya2)), the length (e.g., physical region length XLa2, YLa2), and region number two (or the priority 115 (=2)) of the ROI corresponding to the other ROI image data 112.

The normal image decoding section 218 decodes the Payload Data 215B to generate normal image data 218A. The ROI decoding section 217 decodes the compressed image data 137B included in the Payload Data 215A to generate image data 217A. The image data 217A includes the one or the plurality of pieces of ROI image data 112.

The SLVS-EC processing unit 220 extracts the one or the plurality of pieces of ROI image data 112 and the one or the plurality of pieces of ROI information 116 from the transmission data 147A corresponding to the SLVS-EC specification. The SLVS-EC processing unit 220 includes, for example, a header separation section 221, a header interpretation section 222, a Payload separation section 223, an EBD interpretation section 224, an ROI data separation section 225, an information extraction section 226, an ROI decoding section 227, and a normal image decoding section 228.

The header separation section 221 receives the transmission data 147A from the image sensor 100 via the data bus B1. The header separation section 211 separates the received transmission data 147A in accordance with a rule defined by the SLVS-EC specification.

The header interpretation section 222 interprets contents indicated by header data. As a specific example, the header interpretation section 222, in accordance with the header information type set in three bits at the head of the extended region of the packet header, recognizes a format of information set in another region other than such three bits at the head of the extended region. Then, the header interpretation section 222 reads various types of information set in the extended region in accordance with a recognition result of such a format. This enables the header interpretation section 222 to recognize that information on the region (ROI) (e.g., region data) is transmitted or that the payload is utilized to transmit the coordinates of the region, for example, on the basis of the information set in the extended region. Then, the header interpretation section 222 notifies the Payload separation section 223 of settings recognized in accordance with a read result of the various types of information set in the extended region. Specifically, in a case of recognizing that the information on the region (ROI) (e.g., the region data) is transmitted or that the payload is utilized to transmit the coordinates of the region, the header interpretation section 222 notifies the Payload separation section 223 of such a recognition result.

On the basis of an interpretation result in the header interpretation section 222, the Payload separation section 223 separates the additional information and the image data (normal data or region data) from the payload data. For example, in a case where the packet to be processed is the packet A2 or A3, the Payload separation section 223 may separate the additional information (the Embedded Data) from the packet.

As another example, in a case where the packet to be processed is the packet A1, the Payload separation section 223 separates the image data from the payload data. For example, in a case where the region data is stored in the payload, the Payload separation section 223 may separate such region data from the payload data, depending on an interpretation result of the packet header. In addition, at this time, the Payload separation section 223 may separate the coordinates of the region inserted into the head portion of the payload (i.e., the X-Y coordinates of the partial region) depending on the interpretation result of the packet header. In addition, in a case where the normal data is stored in the payload, the Payload separation section 223 may separate such normal data from the payload data depending on the interpretation result of the packet header.

The Payload separation section 223 transmits, to the EBD interpretation section 224, the additional information among various types of data separated from the payload data. In addition, the Payload separation section 223 transmits, to the ROI data separation section 225, the image data (the region data or the normal data) among various types of data separated from the payload data. In addition, at this time, the Payload separation section 223 may associate the region data with the coordinates of a region corresponding to such region data (i.e., the X-Y coordinates of the partial region) before transmittance to the ROI data separation section 225.

The EBD interpretation section 224 interprets contents of the additional information (the Embedded Data) to output an interpretation result 224A of such additional information to the information extraction section 226. In addition, the EBD interpretation section 224 may transmit the interpretation result 224A of such additional information to the ROI data separation section 225. It is to be noted that the format of the additional information (the Embedded Data) is as described above with reference to FIG. 9.

In a case where the image data transmitted from the Payload separation section 223 is compressed image data 120A of the ROI image data 112, the ROI data separation section 225 outputs, as the Payload Data 215A, the image data separated from the payload data to the ROI decoding section 227. In a case where the image data transmitted from the Payload separation section 223 is compressed image data 130A of the normal image data, the ROI data separation section 225 outputs, as the Payload Data 215B, the image data separated from the payload data to the normal image decoding section 228.

The information extraction section 226 extracts the ROI information 116 from the interpretation result 224A of the additional information. For example, the information extraction section 226 extracts, from the interpretation result 224A of the additional information, for example, the number of ROIs included in the image data 111, the region number (or the priority 115) of each ROI, the data length of each ROI, and the image format of each ROI. That is, the transmission data 147A includes the region number (or the priority 115) of the ROI corresponding to each ROI image data 112, as determination information that is able to determine which of the plurality of pieces of ROI image data 112 obtained from such transmission data 147A has been subjected to omission of the image 118 of the overlapped region ROO.

The normal image decoding section 228 decodes the Payload Data 225B to generate normal image data 228A. The ROI decoding section 227 decodes the compressed image data 147B included in the Payload Data 225A to generate image data 227A. The image data 227A includes the one or the plurality of pieces of ROI image data 112.

The common processing unit 230 generates the one or the plurality of pieces of ROI image data 112 included in the image data 111 on the basis of the output of one of the MIPI processing unit 210 and the SLVS-EC processing unit 220. The common processing unit 230 also generates the image data 111 as the normal image on the basis of the output of one of the MIPI processing unit 210 and the SLVS-EC processing unit 220. In a case where the processor 200 inputs a control signal instructing cutout of the ROI to the image sensor 100 via the control bus B2, the common processing unit 230 executes image processing on the basis of the generated plurality of pieces of ROI image data 112. In a case where the processor 200 inputs a control signal instructing output of the normal image to the image sensor 100 via the control bus B2, the common processing unit 230 executes image processing on the basis of the generated image data 111.

The common processing unit 230 includes, for example, three selection sections 231, 232, and 234, an ROI image generation section 233, and an image processing section 235.

The two selection sections 231 and 232 each select the output of one of the MIPI processing unit 210 (the information extraction section 216 and the ROI decoding section 217) and the SLVS-EC processing unit 220 (the information extraction section 226 and the ROI decoding section 227) to output the selected output to the ROI image generation section 233. The selection section 234 selects the output of one of the MIPI processing unit 210 (the normal image decoding section 218) and the SLVS-EC processing unit 220 (the normal image decoding section 228) to output the selected output to the image processing section 235.

The ROI image generation section 233 generates the image of each ROI (the ROI image data 112) in the image data 111 on the basis of the outputs of the two selection selections 231 and 232. In a case where the processor 200 inputs a control signal instructing cutout of the ROI to the image sensor 100 via the control bus B2, the image processing section 235 performs image processing using the image of each ROI (the ROI image data 112) in the image data 111. Meanwhile, in a case where the processor 200 inputs a control signal instructing output of the normal image to the image sensor 100 via the control bus B2, the image processing section 235 performs image processing using the image data 111.

### Effects

Next, description is given of effects of the communication system 1000 according to the present embodiment.

In recent years, applications for transmitting large amounts of data having a large data volume have been increasing. Transmission systems are likely to be heavily loaded, and in the worst case, there is a possibility that the transmission systems may go down and data transmission may not be performed.

In order to prevent the transmission systems from going down, for example, instead of transmitting the entirety of a photographed image, only a partial image obtained by specifying an object to be photographed and cutting out the specified object has been transmitted.

Incidentally, as a method used for transmission from an image sensor to an application processor, the MIPI CSI-2, the MIPI CSI-3, or the like may be used in some cases. In addition, as a method used for transmission from an application processor to a display, the SLVS-EC or the like may be used in some cases.

In a case where these methods are used to transmit a partial region (ROI (Region Of Interest)) cut out from a captured image, in order to adapt to a plurality of transmission methods, it is necessary to provide a transmitter and a receiver for each of the corresponding transmission methods, which requires improvements in terms of costs and device sizes.

Meanwhile, in the present embodiment, both of the image sensor 100 and the processor 200 are adapted to the two transmission methods (the MIPI CSI-2 or the MIPI CSI-3 and the SLVS-EC). Here, in the image sensor 100, a processing block (the common processing unit 120) that can be common to the MIPI CSI-2 or the MIPI CSI-3 and the SLVS-EC is shared. Further, in the processor 200, a processing block (the common processing unit 230) that can be common to the MIPI CSI-2 or the MIPI CSI-3 and the SLVS-EC is shared.

Specifically, in the image sensor 100, a processing block is shared that performs processing of cutting out the ROI image data 112 from the image data 111 obtained by the imaging unit 110 and processing of generating the information (the ROI information 116 and the frame information 117) necessary for generating pieces of the transmission data 137A and 147A corresponding to the respective transmission methods. In addition, in the processor 200, a processing block is shared that performs processing of generating (restoring) the ROI image data 112. This makes it possible to reduce the size of the circuit and thus to reduce the costs, as compared with a case where processing blocks are separately provided in order to be adapted to the MIPI CSI-2 or the MIPI CSI-3 and the SLVS-EC.

### 2. Modification Example

In the above embodiment, the MIPI CSI-2 or the MIPI CSI-3 and the SLVS-EC have been mentioned as a plurality of adaptable transmission methods. However, in the foregoing embodiment, even in a case of adapting to a plurality of transmission methods different therefrom, it is possible, on side of the transmitter, to share the processing block that performs processing of cutting out the ROI image data from the image data obtained by imaging and processing of generating the information (ROI information and frame information) necessary for generating the transmission data. In addition, it is possible, on side of the receiver, to share the processing block that performs processing of generating (restoring) the ROI image data.

Although the description has been given hereinabove of the present disclosure with reference to the embodiment and modification example thereof, the present disclosure is not limited to the foregoing embodiment, etc., and various modifications may be made. It is to be noted that the effects described herein are merely illustrative. The effects of the present disclosure are not limited to those described herein. The present disclosure may have other effects than those described herein.

In addition, for example, the present disclosure may have the following configurations.

(1)

A transmitter including:

a cut-out section that cuts out, from image data obtained by imaging, one or a plurality of pieces of ROI (Region Of Interest) image data included in the image data;

a deriving section that derives ROI positional information in the image data;

a first processing unit that generates first transmission data corresponding to a first transmission method on a basis of the one or the plurality of pieces of ROI image data and one or a plurality of pieces of the ROI positional information in the image data; and

a second processing unit that generates second transmission data corresponding to a second transmission method on a basis of the one or the plurality of pieces of ROI image data and the one or the plurality of pieces of the ROI positional information in the image data.

(2)

The transmitter according to (1), in which

the first processing unit synthesizes the one or the plurality of pieces of the ROI positional information as Embedded Data with the first transmission data, and

the second processing unit synthesizes the one or the plurality of pieces of the ROI positional information as Embedded Data with the second transmission data.

(3)

The transmitter according to (2), in which

the first processing unit synthesizes, with the first transmission data, header information including the Embedded Data and header ECC information to perform error detection or correction on the header information, and

the second processing unit synthesizes, with the second transmission data, header information including the Embedded Data and header ECC information to perform error detection or correction on the header information.

(4)

The transmitter according to (1), in which

the first processing unit synthesizes the one or the plurality of pieces of ROI image data as Payload Data with the first transmission data, and

the second processing unit synthesizes the one or the plurality of pieces of ROI image data as Payload Data with the second transmission data.

(5)

The transmitter according to (4), in which

the first processing unit synthesizes, with the first transmission data, Payload Data ECC information to perform error detection or correction on the Payload Data, and

the second processing unit synthesizes, with the second transmission data, Payload Data ECC information to perform error detection or correction on the Payload Data.

(6)

The transmitter according to (1), in which

the first processing unit synthesizes, with the first transmission data, the one or the plurality of pieces of the ROI positional information as Embedded Data and the one or the plurality of pieces of ROI image data as Payload Data,

the second processing unit synthesizes, with the second transmission data, the one or the plurality of pieces of the ROI positional information as Embedded Data and the one or the plurality of pieces of ROI image data as Payload Data,

the first processing unit synthesizes, with the first transmission data, at least one of header information including the Embedded Data, header ECC information to perform error detection or correction on the header information, or Payload Data ECC information to perform error detection or correction on a packet footer or the Payload Data, and

the second processing unit synthesizes, with the second transmission data, at least one of header information including the Embedded Data, header ECC information to perform error detection or correction on the header information, or Payload Data ECC information to perform error detection or correction on a packet footer or the Payload Data.

(7)

A receiver including:

a first processing unit that extracts one or a plurality of pieces of image data and one or a plurality of pieces of positional information from first transmission data corresponding to a first transmission method;

a second processing unit that extracts one or a plurality of pieces of image data and one or a plurality of pieces of positional information from second transmission data corresponding to a second transmission method; and

a generation section that generates one or a plurality of pieces of ROI image data included in captured image data obtained by imaging on a basis of the one or the plurality of pieces of image data and the one or the plurality of pieces of positional information extracted by the first processing unit or the second processing unit.

(8)

The receiver according to (7), in which

the first processing unit extracts the one or the plurality of pieces of positional information from Embedded Data included in the first transmission data, and

the second processing unit extracts the one or the plurality of pieces of positional information from Embedded Data included in the second transmission data.

(9)

The receiver according to (7), in which

the first processing unit extracts the one or the plurality of pieces of image data from Payload Data included in the first transmission data, and

the second processing unit extracts the one or the plurality of pieces of image data from Payload Data included in the second transmission data.

(10)

A communication system including:

a transmitter; and

a receiver,

the transmitter including
a cut-out section that cuts out, from image data obtained by imaging, one or a plurality of pieces of ROI image data included in the image data,
a deriving section that derives ROI positional information in the image data,
a first processing unit that generates first transmission data corresponding to a first transmission method on a basis of the one or the plurality of pieces of ROI image data and one or a plurality of pieces of the ROI positional information in the image data, and
a second processing unit that generates second transmission data corresponding to a second transmission method on a basis of the one or the plurality of pieces of ROI image data and the one or the plurality of pieces of the ROI positional information in the image data, and

the receiver including
a first processing unit that extracts one or a plurality of pieces of image data and the one or the plurality of pieces of positional information from the first transmission data,
a second processing unit that extracts the one or the plurality of pieces of image data and the one or the plurality of pieces of positional information from the second transmission data, and
a generation section that generates one or a plurality of pieces of ROI image data included in the image data on a basis of the one or the plurality of pieces of image data and the one or the plurality of pieces of positional information extracted by the first processing unit or the second processing unit.

According to the transmitter of an embodiment of the present disclosure, a processing block that cuts out, from image data obtained by imaging, the one or the plurality of pieces of ROI image data included in the image data and derives the ROI positional information in the image data is shared by the first transmission method and the second transmission method, thus making it possible to adapt to a plurality of transmission methods.

In addition, according to the receiver of an embodiment of the present disclosure, a processing block that performs processing of generating the one or the plurality of pieces of ROI image data is shared by the first transmission method and the second transmission method, thus making it possible to adapt to a plurality of transmission methods.

In addition, according to the communication system of an embodiment of the present disclosure, a processing block that cuts out, from image data obtained by imaging, the one or the plurality of pieces of ROI image data included in the image data and derives the ROI positional information in the image data is shared by the first transmission method and the second transmission method, and a processing block that performs processing of generating the one or the plurality of pieces of ROI image data is shared by the first transmission method and the second transmission method, thus making it possible to adapt to a plurality of transmission methods.

It is to be noted that effects of the present disclosure are not necessarily limited to the effects described here, and may be any of the effects described in the present specification.

This application claims the benefit of Japanese Priority Patent Application JP2019-139884 filed with the Japan Patent Office on Jul. 30, 2019, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A transmitter comprising:
a cut-out section that cuts out, from image data obtained by imaging, one or a plurality of pieces of ROI (Region Of Interest) image data included in the image data;
a deriving section that derives ROI positional information in the image data;
a first processing unit that generates first transmission data corresponding to a first transmission method on a basis of the one or the plurality of pieces of ROI image data and one or a plurality of pieces of the ROI positional information in the image data; and
a second processing unit that generates second transmission data corresponding to a second transmission method on a basis of the one or the plurality of pieces of ROI image data and the one or the plurality of pieces of the ROI positional information in the image data.

2. The transmitter according to claim 1, wherein
the first processing unit synthesizes the one or the plurality of pieces of the ROI positional information as Embedded Data with the first transmission data, and
the second processing unit synthesizes the one or the plurality of pieces of the ROI positional information as Embedded Data with the second transmission data.

3. The transmitter according to claim 2, wherein
the first processing unit synthesizes, with the first transmission data, header information including the Embedded Data and header ECC information to perform error detection or correction on the header information, and
the second processing unit synthesizes, with the second transmission data, header information including the Embedded Data and header ECC information to perform error detection or correction on the header information.

4. The transmitter according to claim 1, wherein
the first processing unit synthesizes the one or the plurality of pieces of ROI image data as Payload Data with the first transmission data, and
the second processing unit synthesizes the one or the plurality of pieces of ROI image data as Payload Data with the second transmission data.

5. The transmitter according to claim 4, wherein
the first processing unit synthesizes, with the first transmission data, Payload Data ECC information to perform error detection or correction on the Payload Data, and
the second processing unit synthesizes, with the second transmission data, Payload Data ECC information to perform error detection or correction on the Payload Data.

6. The transmitter according to claim 1, wherein
the first processing unit synthesizes, with the first transmission data, the one or the plurality of pieces of the ROI positional information as Embedded Data and the one or the plurality of pieces of ROI image data as Payload Data,
the second processing unit synthesizes, with the second transmission data, the one or the plurality of pieces of the ROI positional information as Embedded Data and the one or the plurality of pieces of ROI image data as Payload Data,
the first processing unit synthesizes, with the first transmission data, at least one of header information including the Embedded Data, header ECC information to perform error detection or correction on the header information, or Payload Data ECC information to perform error detection or correction on a packet footer or the Payload Data, and
the second processing unit synthesizes, with the second transmission data, at least one of header information including the Embedded Data, header ECC information to perform error detection or correction on the header information, or Payload Data ECC information to perform error detection or correction on a packet footer or the Payload Data.

7. A receiver comprising:
a first processing unit that extracts one or a plurality of pieces of image data and one or a plurality of pieces of positional information from first transmission data corresponding to a first transmission method;
a second processing unit that extracts one or a plurality of pieces of image data and one or a plurality of pieces of positional information from second transmission data corresponding to a second transmission method; and
a generation section that generates one or a plurality of pieces of ROI image data included in captured image data obtained by imaging on a basis of the one or the plurality of pieces of image data and the one or the plurality of pieces of positional information extracted by the first processing unit or the second processing unit.

8. The receiver according to claim 7, wherein
the first processing unit extracts the one or the plurality of pieces of positional information from Embedded Data included in the first transmission data, and
the second processing unit extracts the one or the plurality of pieces of positional information from Embedded Data included in the second transmission data.

9. The receiver according to claim 7, wherein
the first processing unit extracts the one or the plurality of pieces of image data from Payload Data included in the first transmission data, and
the second processing unit extracts the one or the plurality of pieces of image data from Payload Data included in the second transmission data.

10. A communication system comprising:
a transmitter; and
a receiver,
the transmitter including
a cut-out section that cuts out, from image data obtained by imaging, one or a plurality of pieces of ROI image data included in the image data,
a deriving section that derives ROI positional information in the image data,
a first processing unit that generates first transmission data corresponding to a first transmission method on a basis of the one or the plurality of pieces of ROI image data and one or a plurality of pieces of the ROI positional information in the image data, and
a second processing unit that generates second transmission data corresponding to a second transmission method on a basis of the one or the plurality of pieces of ROI image data and the one or the plurality of pieces of the ROI positional information in the image data, and
the receiver including
a first processing unit that extracts one or a plurality of pieces of image data and the one or the plurality of pieces of positional information from the first transmission data,
a second processing unit that extracts the one or the plurality of pieces of image data and the one or the plurality of pieces of positional information from the second transmission data, and
a generation section that generates one or a plurality of pieces of ROI image data included in the image data on a basis of the one or the plurality of pieces of image data and the one or the plurality of pieces of positional information extracted by the first processing unit or the second processing unit.
